(19) United States
(12) Patent Application Publication
(10) Pub. No.: US 2022/0356721 A1
(43) Pub. Date: Nov. 10, 2022

(54) RAFTER SPACING SYSTEM

(71) Applicant: Verlon Caskey, Spicer, MN (US)

(72) Inventor: Verlon Caskey, Spicer, MN (US)

(21) Appl. No.: 17/660,575

(22) Filed: Apr. 25, 2022

Related U.S. Application Data
(60) Provisional application No. 63/201,532, filed on May 4, 2021.

(51) Int. Cl. E04G 21/18; B25B 5/06; B25B 5/00

(52) U.S. Cl. CPC E04G 21/1891; B25B 5/06; B25B 5/006

(57) ABSTRACT

A system for spacing rafters can include an outer member, an inner member, jaws, and a handle. The handle can be movably connected to the inner member and the outer member. The jaws can be secured to the inner member or the outer member. The handle can be operable to move the jaws with respect to each other to equally space the rafters with respect to each other.

### CLAIM OF PRIORITY

This patent application claims the benefit of priority, under 35 U.S.C. Section 119(e), to Verlon Caskey U.S. Patent Application Ser. No. 63/201,532, entitled “RAFTER SPACING SYSTEM,” filed on May 4, 2021, which is hereby incorporated by reference herein in its entirety.

### BACKGROUND

In construction, rafters or trusses are used in framing of roofs of buildings such as homes, barns, and garages. The spacing of rafters or trusses is an important aspect in the design and construction of a roof structure that meets building codes or other requirements.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a perspective view of a spacing system.

FIG. 2A illustrates a perspective view of spacing system engaging a plurality of rafters in a first configuration.

FIG. 2B illustrates a perspective view of a spacing system engaging a plurality of rafters in a second configuration.

FIG. 3 illustrates a partially exploded view of a spacing system.

FIGS. 4A-4B illustrates a perspective view of an inner and an outer body of a spacing system.

FIG. 5A illustrates a perspective view of a second jaw of a clamp of a spacing system.

FIGS. 5B-5C illustrate perspective views of a handle and brackets of a spacing system.

### DETAILED DESCRIPTION

A rafter is a structural beam which typically extends along a slope between an edge and a peak of a roof. During the roof framing process, rafters are laid along and affixed to the edge and peak in series (e.g., side by side) to provide a solid support base for the roof sheathing and other coverings. The spacing between the rafters is measured from a center of a horizontal surface of one rafter to a center of a horizontal surface of an adjacent rafter. The spacing between rafters or trusses along with the type material used, such the type of timber, and the physical width of the rafters, are all essential variables in determining a type and magnitude of load the roof structure is able to support. For example, these factors can be used to determine a maximum span of the rafters dictating how wide a building under the roof can be. There are several industry-standard spacings in use in the United States, as a result of rafter spacing being a fraction of available roof sheathing materials. For example, the most common size and material used for roof sheathing material is a 4 foot×8 foot (1.22 meters×2.44 meters) sheet of plywood, and as such, the most commonly used spacings are 12, 16, or 24 inches on-center (30.48 cm, 40.64 cm, or 60.96 cm). As this spacing distance is relatively small compared to the size of most buildings, a significant number of rafters are used in the construction of even relatively small structures; larger structures can require hundreds of rafters. This can make the process of measuring the center-to-center distance (e.g., spacing) between each new rafter and a previously laid rafter a labor intensive and time-consuming operation, particularly as the spacing is usually measured by hand, such as with a tape measure or a piece of timber cut to the selected spacing. Moreover, in some situations it can be difficult for a single worker to concurrently measure and affix, such as with nails or screws, each railer in the correct position without accidentally moving another rafter.

The present disclosure can help to address the above issues, among others, such as by providing a universal rafter spacing system capable of allowing a single user to concurrently locate and retain plurality of rafters in linear and equidistant position with respect to one another. The framing spacer can be a simple, easily portable, and relatively inexpensive system to provide a practical and improved alternative to manually and individually measuring the spacing between rafters. While the above overview discusses examples generally pertaining to rafter spacing, discussion of the following systems, devices, or methods are also applicable for use in the spacing of other types of roof support structures, such as roof trusses or joists which may also be spaced similarly to rafters. The above overview is intended to provide an overview of subject matter of the present patent application. It is not intended to provide an exclusive or exhaustive explanation of the invention. The description below is included to provide further information about the present patent application.

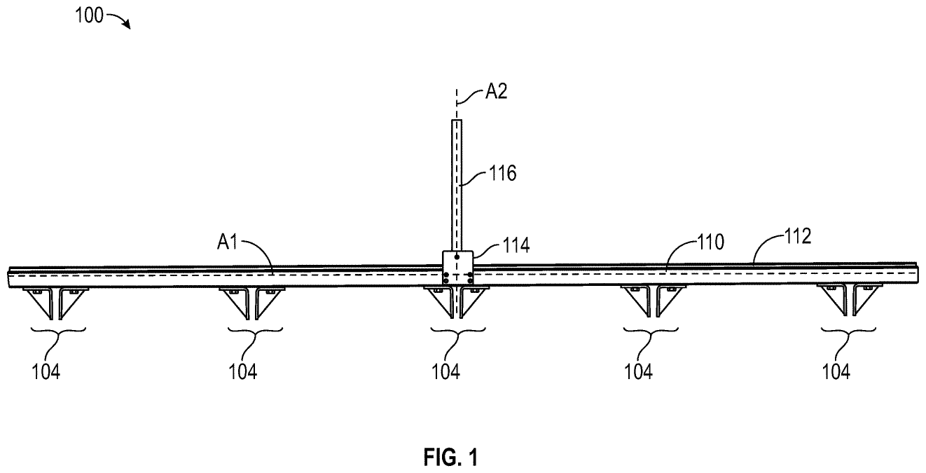

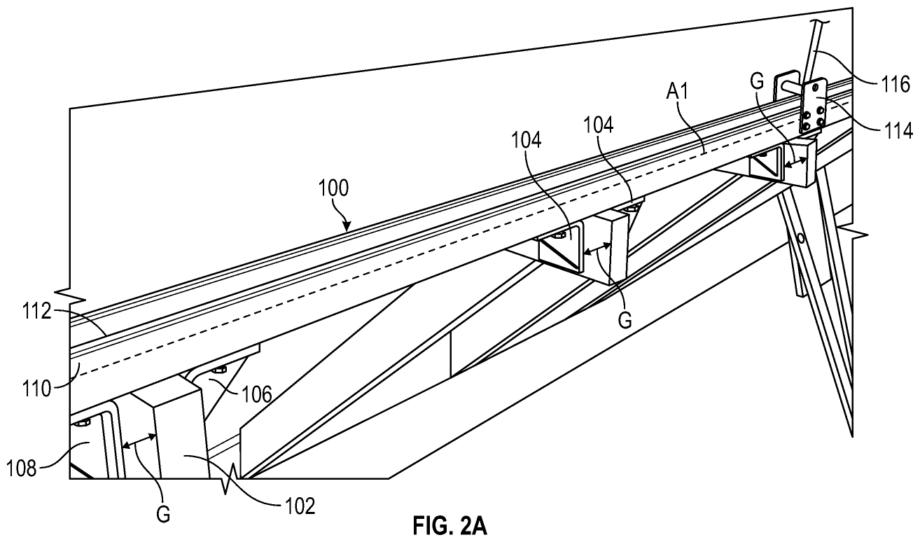

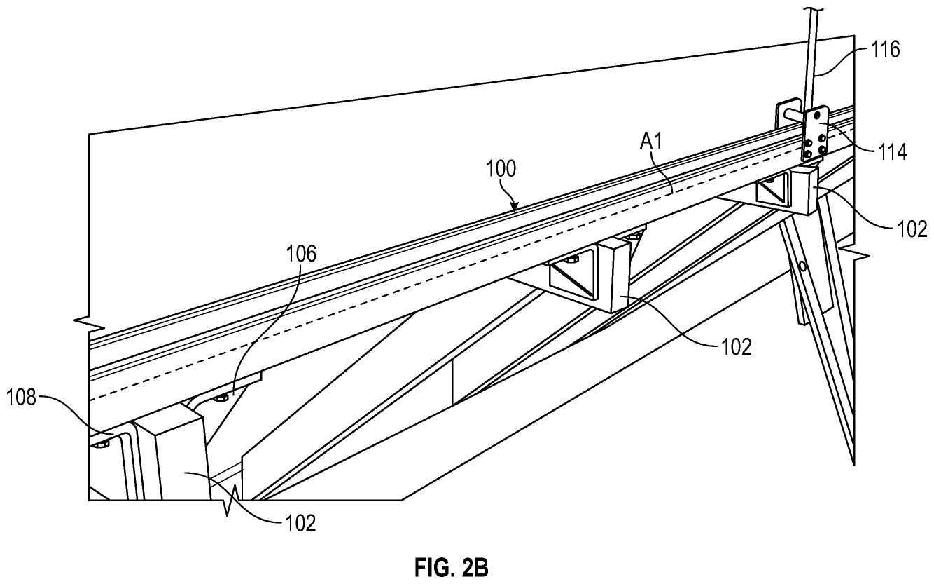

FIG. 1 illustrates a perspective view of a spacing system 100, in accordance with at least one example of the present application. FIG. 2A illustrates a perspective view of a spacing system 100 engaging a plurality of rafters 102 in a first configuration, in accordance with at least one example of the present application. FIG. 2B illustrates a perspective view of a spacing system 100 engaging a plurality of rafters 102 in a second position, in accordance with at least one example of the present application. Also shown in FIGS. 1-2B is a first axis A1 and a second axis A2. FIGS. 1-2B are discussed below concurrently.

The spacing system 100 can be configured to receive and engage the plurality of rafters 102, such as to concurrently locate and retain each of the rafters 102 in linear and equidistant positions with respect to one another. The rafters 102 can be rectangular beams, such as made from wood, aluminum, steel, or the like. The spacing system 100 can include a plurality of clamps 104. Each of the clamps 104 can include a first jaw 106 and a second jaw 108 (shown in FIG. 2B).

The spacing system 100 can include an outer body (or first body) 110, which can be a formed channel, and an inner body (or second body) 112, which can be a formed member, positioned within the outer body 110. The outer body 110 can define the first axis A1, which can be a longitudinal or central axis of the framing system 100. The outer body 110 can be configured to support the spacing system 100 on and along each of the rafters 102. For example, the outer body 110 can concurrently extend over a horizontal width of the rafters 102. The inner body 112 can be configured, such as by being sized or shaped, to be axially received within the first body 110. Though the inner body 112 is discussed as being positioned within the outer body 110, the bodies can be positioned on top of each other, adjacent to each other, or the like.

Each of the clamps 104 can extend parallel to, and equally offset from, the first axis A1. The first jaws 106 of each of the clamps 104 can be connected to and can extend from the outer body 110. The second jaws 108 of each of the clamps 104 can be connected to and can extend from the inner body 112.

The spacing system 100 can also include brackets 114 and a handle 116. The brackets 114 can be connected to the first body 110. The handle 116 can operatively couple the first body 110 to the second body 112. For example, the handle 116 can be pivotably coupled to both the first body 110, such as via the brackets 114, and to the second body 112. The handle 116 can be movable between a first position and a second position to cause relative translation between the outer 110 and inner 112 bodies along the first axis A1, such as to move the spacing system 100 between a first configuration and a second configuration.

As shown in FIG. 2A, the spacing system 100 can be in the first configuration when the handle 116 is located in the first position where the handle 116 is angled (non-perpendicular) with respect to the axis A1. When the spacing system 100 is in the first configuration, the clamps 104 can be spaced apart from the rafters 102 by gap G, such that the jaws 106 and 108 can receive the rafters 102 between the jaws 106 and 108.

As shown in FIGS. 1 and 2B, the handle 116 can be operated to move the spacing system 100 to the second configuration, such that the handle 116 is perpendicular to the axis A1, which can cause the inner body 112 to move with respect to the outer body 110. When the spacing system 100 is moved to the second configuration, the first 106 and the second 108 jaws can contact opposing surfaces of the rafters 102 to retain the rafters 102 at predetermined locations along the first axis A1 (eliminating gap G). The predetermined locations can correspond to a desired rafter spacing, such as defined by the distance between a point between and equidistant to first jaws 106 and the second jaws 108, when the spacing system 100 is in the second configuration. For example, the predetermined locations can be spaced 12, 16, 24, 30, 36, 48, or the like inches apart (e.g., 24 inches on center). The spacing system 100 can thereby concurrently locate the rafters 102 in parallel equidistant positions with respect one another by operating the handle 116.

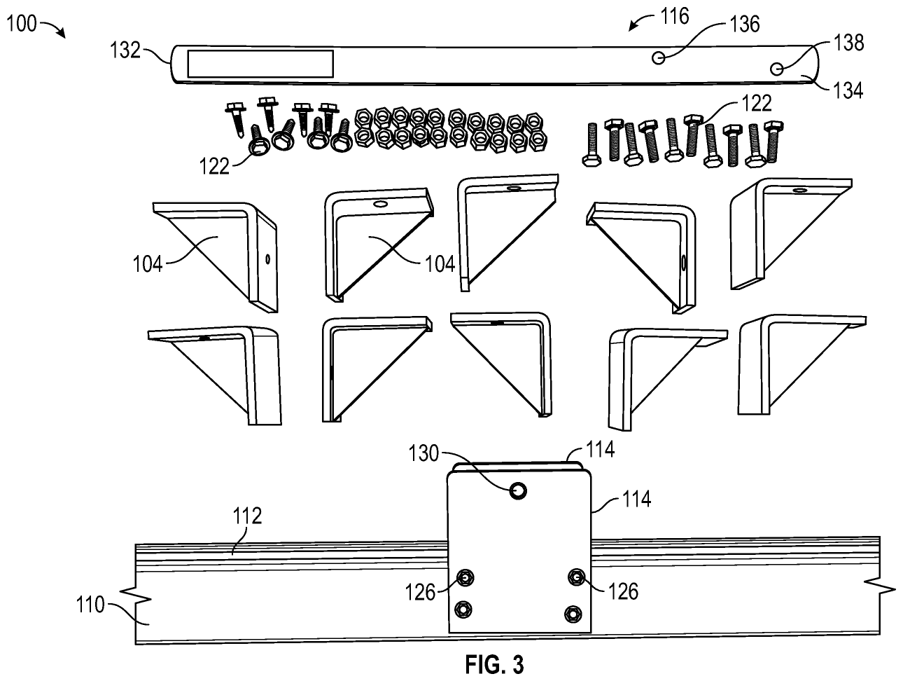

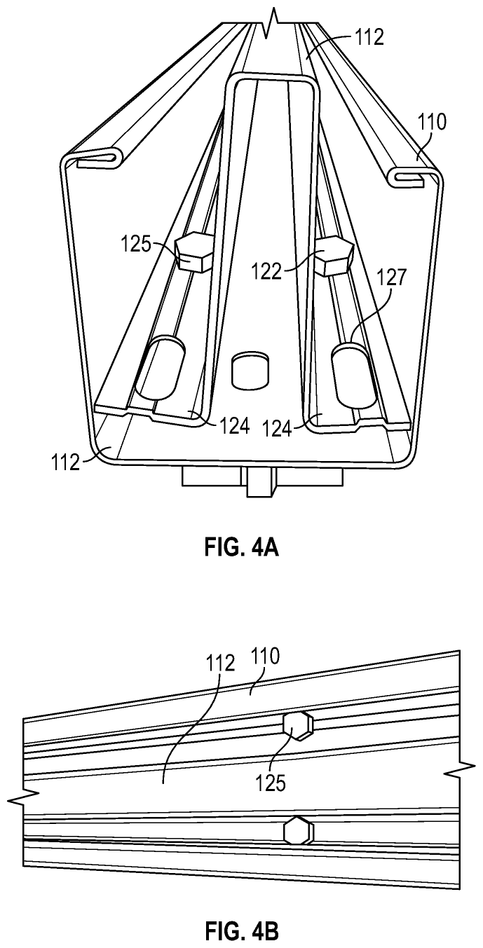

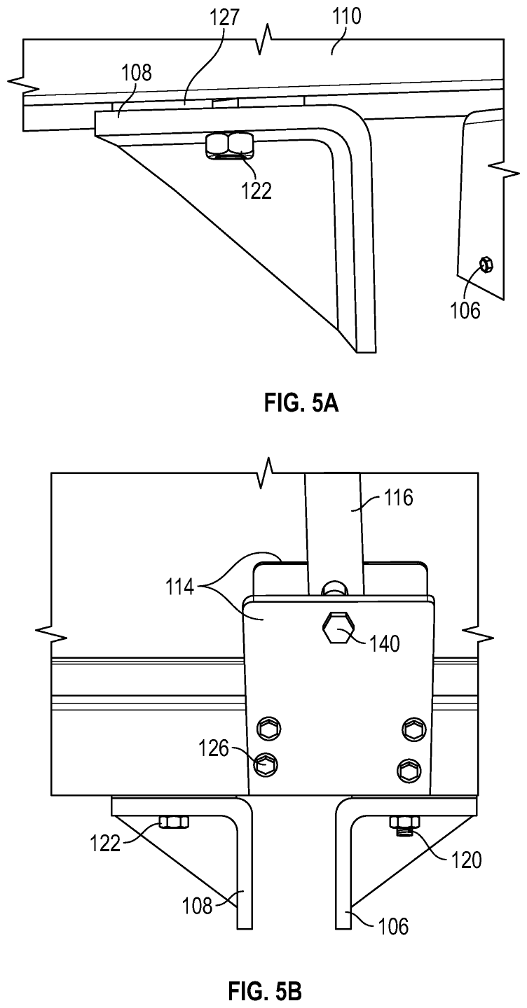

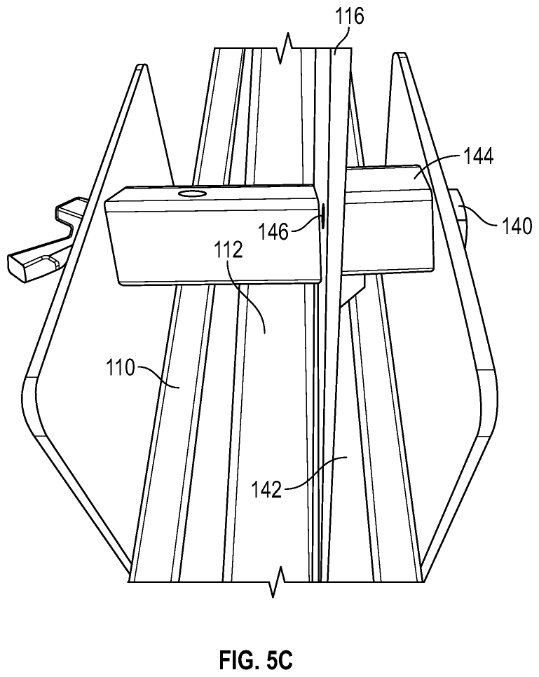

FIG. 3 illustrates a partially exploded view of a spacing system 100, in accordance with at least one example of the present application. FIGS. 4A-4B illustrates a perspective view of an outer 110 and an inner 112 body of a spacing system 100, in accordance with at least one example of the present application. FIG. 5A illustrates a perspective view of a second jaw 108 of a clamp 104 of a spacing system 100, in accordance with at least one example of the present application. FIGS. 5B-5C illustrate perspective views of a handle 116 and brackets 114 of a spacing system 100, in accordance with at least one example of the present application. FIGS. 3-5C are discussed below concurrently; and with reference to various aspects shown in or described with regard to FIGS. 1-2B above.

The outer 110 body and inner body 112 can each generally be a beam, such as in the form of a channel bar or an angle bar, but can form other three-dimensional shapes such as triangular, rectangular, or hexagonal prisms. The spacing system 100 can include at least two, but can also include three, four, five, six, or still other numbers of clamps 104. The clamps 104 can be spaced in a linear arrangement along the outer 110 and inner 112 bodies, such as parallel to the first axis A1 and generally between opposite first and second ends of the outer 110 or inner 112 bodies. The first 106 and the second jaws 108 of the clamps 104 can be brackets, such as defining two faces located orthogonally with respect to each other. For example, one of the two faces can extend parallel to the first axis A1, and one of the two faced can extend orthogonally thereto, such as to extend parallel to the second axis A2 and a vertical surface of the rafters 102.

The spacing system 100 can include fasteners 120 and 122. The fasteners 120 and 122 can be screws, bolts, including corresponding nuts (such as wingnuts to allow rapid disassembly of the spacing system 100), rivets, or the like. The first jaws 106 can be fixedly coupled to the outer body 110 via the fasteners 120, such as extending through a surface of the outer body 110 and a surface of each first jaw 106. The second jaws 108 can be fixedly coupled to the inner body 112 via the fasteners 122, such as extending transversely through surfaces of the inner body 112, the outer body 110, and a surface of each first jaw 106.

The inner body 112 can include flanges 124, through which the fasteners 122 can extend to engage the second jaws 108. The flanges 124 can extend outward from the inner body 112 toward the outer body 110, such as to contact the outer body 110 to limit transverse translation relative to the first axis A1, of the inner body 112 within the outer body 110. The fasteners 122 can extend through bores 125 of the inner body 112 and can further extend through oblong or otherwise longitudinal slots 127 or apertures of the outer body 110. As such, the axial or longitudinal length of such slots or apertures can be configured to limit axial or translation of the inner body 112 and the second jaws 108 relative to the outer body 110 and the first jaws 106, such as to control a center-to-center spacing of the rafters 102. Optionally, the spacing system 100 can be configured to concurrently space the plurality of rafters 102 at various spacing options, such as by changing a location of the clamps 104 along the outer 110 and inner 112 bodies.

As shown in FIG. 3, the spacing system can include fasteners 126. The fasteners 126 can be, for example, but not limited to, screws, bolts, including corresponding nuts (such as wingnuts to allow rapid disassembly of the spacing system 100), rivets, or the like. The brackets 114 can be connected to the outer body 110 via the fasteners 126, such by extending through bores defined by the outer body 110 and the brackets 114.

As shown in FIG. 3, the handle 116 can be a bar, such as in the form of a flat bar or square bar; but can form other three-dimensional shapes such as a cylinder or a triangular, rectangular, or hexagonal prisms. The handle 116 can include a first portion 132 and a second portion 134 that can generally be opposite segments or ends of the handle 116. The second portion 134 can include a first aperture 136 and a second aperture 138 extending transversely through the handle 116.

As shown in FIG. 5C, the spacing system 100 can further include a crossmember 144. The crossmember 144 can for example, be a beam, such as in the form of a square bar, but can form other three-dimensional shapes such as a cylinder or triangular, rectangular, or hexagonal prisms. The crossmember 144 can extend transversely between the brackets 114, such as to laterally support to the brackets 114 with respect to each other. The crossmember 144 can receive the outer fastener 140, such as within a longitudinal bore defined by the crossmember 144. The crossmember 144 can define a notch 146. The notch 146 can be configured to receive and contact the second portion 134 of the handle 116, such as to both laterally and longitudinally support and position the handle 116.

As shown in FIG. 5C, the spacing system 100 can include an outer fastener 140 and an inner fastener 142. The outer 140 and the inner 142 fasteners can be, for example, but not limited to, screws, bolts, rivets, or the like. The outer 140 fastener can extend through the first aperture 136 and the crossmember 144 connecting the handle to the plates 114 in a pivotable or rotatable arrangement and therefore to connect the handle 116 to the outer member 110 (via the plates 114). The inner 142 fastener can extend through the second aperture 138 to pivotably, and thereby operatively, connect the handle 116 to both the outer 110 and inner 112 bodies, respectively.

In operation of some examples, when the first portion 132 of the handle 116 is pulled, the handle 116 can rotate about the outer fastener 140, which can cause movement of the second portion 134 of the handle 116 with respect to the inner body 112 and the outer body 110. Because the inner body 112 is connected to the second portion 134, rotation of the first portion 132 can cause movement (e.g., translation) of the inner body 112 with respect to the outer body 110. Such translation can cause movement of the second jaw 108 (connected to the inner body 112) with respect to the first jaw 106 to cause, for example, engagement of the first jaw 106 and the second jaw 108 of each clamp 104 with its respective rafter 102 to position each of the rafters 102 such that they are evenly space at a predetermined center-to-center distance, such as of 24 inches.

The handle 116 can optionally be locking or resistant to moving from the locked and centered position, which can help to allow the system 100 to hold the rafters 102 in the desired center-to-center position while a board (such as sheathing) is secured to the rafters 102. Following securing of the board to the rafters, the handle 116 can be rotated in an opposing direction to unlock the clamps 104 allowing the first jaw 106 and the second jaw 108 to disengage the rafters and the system 100 to be removed therefrom. The system 100 can then be moved to another portion of the rafters for spacing of the rafters for attachment of a next board or boards. Such a process can be repeated as desired to space the rafters (or other boards) with respect to each other for framing or sheathing operations.

The spacing system 100, including any of various components thereof, can be made of materials such as including, but not limited to, metals such as steel, aluminum, or alloys, plastics, composites, foams, elastomers, ceramics, or the like or any combinations thereof in view of the above, the spacing system 100 can provide a user with and improved system and method of spacing rafters during roof construction. For example, the spacing system 100 can capable of quickly and conveniently locating a plurality of rafters at positions laterally equidistant to one another concurrently, such as by simply positioning the spacing system 100 with respect to a plurality of rafters and subsequently operating an arm. The spacing system 100 can further be relatively inexpensive, such as by being simple in both componentry and in manufacturing; and easily portable, such as by being capable of rapidly disassembly.

### NOTES AND EXAMPLES

The following, non-limiting examples, detail certain aspects of the present subject matter to solve the challenges and provide the benefits discussed herein, among others.

Example 1 is a system for spacing a plurality of rafters or trusses, the system comprising: a first body defining a longitudinal axis; a second body connected to first body and movable with respect to the first body; a plurality of clamps, each including: a first jaw connected to the first body; and a second jaw connected to the second body, each first jaw and second jaw together configured to engage a rafter of the plurality of rafters; and a handle connected to the first body and the second body, the handle operable to move the second jaws with respect to the first jaws to engage and equally space the plurality of rafters with respect to each other.

In Example 2, the subject matter of Example 1 optionally includes wherein the second body is located at least partially within the first body.

In Example 3, the subject matter of Example 2 optionally includes wherein the first body is a formed channel.

In Example 4, the subject matter of any one or more of Examples 1-3 optionally include wherein the first body includes a plurality of slots extending through a bottom portion thereof and wherein the first body includes a plurality of bores extending through a bottom portion thereof, each bore alignable with one of the slots to receive a fastener through the bore and the slot to secure one of the first jaws to the first body.

In Example 5, the subject matter of Example 4 optionally includes wherein each fastener is engageable with its respective slot when the handle is operated to limit translation of the first body with respect to the second body and each first jaw with respect to each second jaw.

In Example 6, the subject matter of any one or more of Examples 4-5 optionally include wherein the handle is operable to translate the first body within the second body along the longitudinal axis to move the plurality of first jaws with respect to the plurality of second jaws.

Example 7 is a device for spacing rafters or trusses, the device comprising: a first body defining a longitudinal axis; a second body connected to first body and movable with respect to the first body; a first clamp including: a first jaw connected to the first body; and a second jaw connected to the second body, each first jaw and second jaw together configured to engage a first rafter; and a second clamp including: a third jaw connected to the first body; and a fourth jaw connected to the second body, each third jaw and fourth jaw together configured to engage a second rafter; and a handle connected to the first body and the second body, the handle operable to move the first jaw with respect to the second jaw to engage the first rafter, and to move the third jaw with respect to the fourth jaw to engage the second rafter and to space the second rafter with respect to the first rafter.

In Example 8, the subject matter of Example 7 optionally includes a third clamp including: a fifth jaw connected to the first body; and a sixth jaw connected to the second body, each third jaw and fourth jaw together configured to engage a third rafter; wherein the handle is operable to move the fifth jaw with respect to the sixth jaw to engage the third rafter and to space the third rafter equally with respect to the second rafter and the first rafter.

In Example 9, the subject matter of Example 8 optionally includes wherein the second body is located at least partially within the first body.

In Example 10, the subject matter of Example 9 optionally includes wherein the first body is a formed channel.

In Example 11, the subject matter of any one or more of Examples 7-10 optionally include wherein the first body includes a of slot extending through a bottom portion thereof and wherein the first body includes a bore extending through a bottom portion thereof, the bore alignable with the slot to receive a fastener through the bore and the slot to secure the first jaw to the first body.

In Example 12, the subject matter of Example 11 optionally includes wherein the fastener is engageable with the slot when the handle is operated to limit translation of the first body with respect to the second body, the first jaw with respect to each second jaw, and the third jaw with respect to the fourth jaw.

In Example 13, the subject matter of Example 12 optionally includes wherein the handle is operable to translate the first body within the second body along the longitudinal axis to move the first jaw and third jaw with respect to the second jaw and fourth jaw.

Example 14 is a system for spacing at least three rafters, comprising: an outer body defining a longitudinal axis; an inner body axially received within the outer body; at least three clamps located in a linear arrangement with respect to the outer and the inner bodies, wherein the at least three clamps are configured to receive the at least three rafters and include: a first jaw fixedly coupled to the outer body; a second jaw fixedly coupled to the inner body; a handle operably coupling the outer body to the inner body, the handle configured to cause relative axial translation between the outer and inner the bodies, to locate each of the clamps at linear and equidistant positions with respect to one another.

In Example 15, the subject matter of Example 14 optionally includes wherein the first body includes a of slot extending through a bottom portion thereof and wherein the first body includes a bore extending through a bottom portion thereof, the bore alignable with the slot to receive a fastener through the bore and the slot to secure the first jaw to the first body.

In Example 16, the subject matter of Example 15 optionally includes wherein the fastener is engageable with the slot when the handle is operated to limit translation of the first body with respect to the second body, the first jaw with respect to each second jaw, and the third jaw with respect to the fourth jaw.

In Example 17, the subject matter of Example 16 optionally includes wherein the handle is operable to translate the first body within the second body along the longitudinal axis to move the first jaw and third jaw with respect to the second jaw and fourth jaw.

Example 18 is a method of spacing at least three rafters, the method comprising: positioning a spacing system with respect to the at least three rafters, the spacing system including: an outer body defining a longitudinal axis; an inner body axially received within the outer body; at least two clamps located in a linear arrangement with respect to the outer and the inner bodies, wherein the least at least three clamps are configured to receive the at least three rafters and include: a first jaw fixedly coupled to the outer body; a second jaw fixedly coupled to the inner body; a handle operably coupling the outer body to the inner body, the handle configured to cause relative axial translation between the outer and the inner bodies, to locate each of the clamps at linear and equidistant positions with respect to one another; and pivoting the handle from a first position to a second position to cause the relative axial translation between the outer and the inner bodies, to locate the plurality of rafters at linear and equidistant positions with respect to one other.

Example 19 is a method of spacing rafters, the method comprising: positioning a rafter spacing system on two or more rafters; positioning a first rafter in a first clamp of the rafter spacing system; positioning a second rafter in a second clamp of the rafter spacing system; operating a handle of the rafter spacing system to cause the clamps to engage the first rafter and the second rafter to position the first rafter and the second rafter at a predetermined distance from each other.

Example 20 is a system for spacing rafters including any of the features discussed herein.

Example 21 is a method of spacing rafters using any of the steps discussed herein.

In Example 23, the apparatuses or method of any one or any combination of Examples 1-22 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A system for spacing a plurality of rafters or trusses, the system comprising:
a first body defining a longitudinal axis;
a second body connected to first body and movable with respect to the first body;
a plurality of clamps, each including:
a first jaw connected to the first body; and
a second jaw connected to the second body, each first jaw and second jaw together configured to engage a rafter of the plurality of rafters; and
a handle connected to the first body and the second body, the handle operable to move the second jaws with respect to the first jaws to engage and equally space the plurality of rafters with respect to each other.

2. The system of claim 1, wherein the second body is located at least partially within the first body.

3. The system of claim 2, wherein the first body is a formed channel.

4. The system of claim 1, wherein the first body includes a plurality of slots extending through a bottom portion thereof and wherein the first body includes a plurality of bores extending through a bottom portion thereof, each bore alignable with one of the slots to receive a fastener through the bore and the slot to secure one of the first jaws to the first body.

5. The system of claim 4, wherein each fastener is engageable with its respective slot when the handle is operated to limit translation of the first body with respect to the second body and each first jaw with respect to each second jaw.

6. The system of claim 4, wherein the handle is operable to translate the first body within the second body along the longitudinal axis to move the plurality of first jaws with respect to the plurality of second jaws.

7. A device for spacing rafters or trusses, the device comprising:
a first body defining a longitudinal axis;
a second body connected to first body and movable with respect to the first body;
a first clamp including:
a first jaw connected to the first body; and
a second jaw connected to the second body, each first jaw and second jaw together configured to engage a first rafter;
a second clamp including:
a third jaw connected to the first body; and
a fourth jaw connected to the second body, each third jaw and fourth jaw together configured to engage a second rafter; and
a handle connected to the first body and the second body, the handle operable to move the first jaw with respect to the second jaw to engage the first rafter, and to move the third jaw with respect to the fourth jaw to engage the second rafter and to space the second rafter with respect to the first rafter.

8. The device of claim 7, further comprising:
a third clamp including:
a fifth jaw connected to the first body; and
a sixth jaw connected to the second body, each third jaw and fourth jaw together configured to engage a third rafter;
wherein the handle is operable to move the fifth jaw with respect to the sixth jaw to engage the third rafter and to space the third rafter equally with respect to the second rafter and the first rafter.

9. The device of claim 8, wherein the second body is located at least partially within the first body.

10. The device of claim 9, wherein the first body is a formed channel.

11. The device of claim 7, wherein the first body includes a of slot extending through a bottom portion thereof and wherein the first body includes a bore extending through a bottom portion thereof, the bore alignable with the slot to receive a fastener through the bore and the slot to secure the first jaw to the first body.

12. The device of claim 11, wherein the fastener is engageable with the slot when the handle is operated to limit translation of the first body with respect to the second body, the first jaw with respect to each second jaw, and the third jaw with respect to the fourth jaw.

13. The device of claim 12, wherein the handle is operable to translate the first body within the second body along the longitudinal axis to move the first jaw and third jaw with respect to the second jaw and fourth jaw.

14. A system for spacing at least three rafters, comprising:
an outer body defining a longitudinal axis;
an inner body axially received within the outer body; and
at least three clamps located in a linear arrangement with respect to the outer and the inner bodies, wherein the at least three clamps are configured to receive the at least three rafters and include:
a first jaw fixedly coupled to the outer body;
a second jaw fixedly coupled to the inner body; and
a handle operably coupling the outer body to the inner body, the handle configured to cause relative axial translation between the outer and inner the bodies, to locate each of the clamps at linear and equidistant positions with respect to one another.

15. The system of claim 14, wherein the first body includes a of slot extending through a bottom portion thereof and wherein the first body includes a bore extending through a bottom portion thereof, the bore alignable with the slot to receive a fastener through the bore and the slot to secure the first jaw to the first body.

16. The system of claim 15, wherein the fastener is engageable with the slot when the handle is operated to limit translation of the first body with respect to the second body and the first jaw with respect to each second jaw.

17. The system of claim 16, wherein the handle is operable to translate the first body within the second body along the longitudinal axis to move the first jaw and third jaw with respect to the second jaw and fourth jaw.
